(19) United States
(12) Patent Application Publication
(10) Pub. No.: US 2026/0105498 A1
(43) Pub. Date: Apr. 16, 2026

(54) Systems and methodologies for validating and reassessing product or service reviews

(71) Applicant: Daniel Ameer, Glendale, CA (US)

(72) Inventor: Daniel Ameer, Glendale, CA (US)

(21) Appl. No.: 18/914,213

(22) Filed: Oct. 13, 2024

(51) Int. Cl. G06Q 30/0282; G06Q 30/0203

(52) U.S. Cl. CPC G06Q 30/0282; G06Q 30/0203

(57) ABSTRACT

PeerVal is a system designed to reassess and validate user reviews on digital marketplaces using a peer-to-peer, community-based voting mechanism, enhanced by artificial intelligence (AI) and natural language processing (NLP). The system integrates seamlessly with existing marketplace infrastructures, allowing sellers and service providers to flag reviews they deem biased or inaccurate. Through the use of AI, PeerVal selects qualified reassessors from the marketplace community, who then vote on the validity of the flagged review. The system's NLP engine provides context analysis of the review content, offering reassessors insights into the sentiment, key topics, and potential biases within the review. Reassessor votes are collected through a structured voting system, and the outcome is determined by a majority voting mechanism. The result is automatically reflected in the marketplace, where reviews may be upheld or removed based on the outcome.

### BACKGROUND OF THE INVENTION

### Field of Invention

This invention relates to the field of digital marketplaces and e-commerce platforms, specifically to systems and methodologies for validating and reassessing product or service reviews. The invention focuses on creating a peer-to-peer, community-driven process for verifying the authenticity, accuracy, and fairness of user-generated reviews. It leverages technologies such as artificial intelligence (AI), natural language processing (NLP), and community-based voting mechanisms to address issues of biased, fake, or misleading reviews. The invention also introduces a method for automating review validation processes to enhance trust and transparency in online platforms while reducing manual intervention and human labor.

### BRIEF SUMMARY OF THE INVENTION

PeerVal is a peer-to-peer, community-based system designed to validate and reassess product and service reviews on digital marketplaces. By enabling sellers or service providers to flag suspicious or biased reviews for reassessment, PeerVal ensures transparency, fairness, and accuracy in the review process. The system leverages advanced technologies, such as artificial intelligence (AI) and natural language processing (NLP), to select qualified users to serve as reassessors. These reassessors vote on the validity of the flagged review, with outcomes determined by majority vote. The process is automated, reducing the reliance on manual investigation, while offering a fair, community-driven solution to maintaining trustworthy reviews on digital platforms. PeerVal enhances marketplace credibility by addressing the problem of biased, fake, or misleading reviews, ultimately fostering greater trust between buyers and sellers.

### BRIEF DESCRIPTION OF THE FIGURES

FIG. 1: outlines the PeerVal system's process, from the initiation of a review reassessment request to the final automated decision and notification, ensuring accuracy, fairness, and transparency in digital marketplace reviews.

### DETAILED DESCRIPTION

PeerVal is an advanced system for reassessing and validating product and service reviews on digital marketplaces. This community-driven, AI-powered system aims to improve trust, transparency, and fairness in online review systems by enabling sellers or service providers to request a reassessment of reviews. PeerVal works through a comprehensive, automated process that integrates multiple components such as marketplace APIs, AI for reassessor selection, natural language processing (NLP) for review content analysis, optical character recognition (OCR) for text extraction, and visual recognition for analyzing images and videos. Below is a detailed description of each component, along with the system architecture and development code provided to enhance the understanding of PeerVal's unique functionality.

### 1. System Architecture

PeerVal is built on a modular system architecture, designed to handle reassessments of digital marketplace reviews efficiently. The key components are:

### 1.1 Marketplace Integration Module

This API-based module integrates PeerVal with digital marketplaces. It handles requests for reassessments, updates review statuses, and exchanges relevant data between PeerVal and marketplace platforms. This module acts as the primary gateway for marketplace users to engage with the PeerVal system.

### 1.2 Reassessment Request Interface

This user interface allows sellers or service providers to flag reviews they believe to be biased or inaccurate. They can submit supporting documents or evidence to justify their reassessment request. The system verifies eligibility criteria before proceeding with the review.

### 1.3 AI-Powered Reassessor Selection Engine

An AI engine selects a pool of qualified marketplace users to serve as reassessors (voters). Criteria such as user activity, the age of their account, previous review interactions, and their track record of accurate reassessments help ensure fairness and impartiality in the selection process.

### 1.4 NLP-Based Review Context Analysis

Natural Language Processing (NLP) analyzes the content of flagged reviews, identifying key topics, sentiments, and biases. This data helps reassessors by providing a deeper understanding of the review context, leading to more informed voting decisions.

### 1.5 Survey and Voting System

The voting system presents reassessors with structured assessment topics, such as fairness, relevance, and accuracy of the review. Votes are collected and processed through the majority voting mechanism.

### 1.6 Majority Voting Mechanism

Once reassessors submit their votes, the system uses majority voting to determine the outcome. If the majority uphold the review, it remains visible. If deemed invalid, the system cancels the review and removes it from the marketplace.

### 1.7 Automated Review Management

This module automates the status updates of reviews based on the voting outcome. The system automatically removes invalid reviews without manual intervention, reducing the administrative burden on platform operators.

### 1.8 Notification System

Relevant parties (e.g., sellers, original reviewers, reassessors) receive notifications during the reassessment process. Updates include review status changes, requests for additional evidence, and final outcomes.

### 1.9 Data Storage and Auditing

All reassessment requests, votes, and outcomes are stored for auditing, trend analysis, and quality control. This ensures that PeerVal consistently delivers fair and accurate reassessments.

### 2. System Architecture and Technology Stack

PeerVal's system architecture is designed to ensure efficient reassessment and validation of digital marketplace reviews through a well-structured, modular framework. Each component plays a crucial role in handling user requests, AI processing, and decision-making. Here's how the system and technology stack work:

### 2.1 Technology Stack Overview:

### Frontend:

React.js (or Angular/Vue.js): PeerVal uses React.js (or alternatives like Angular or Vue.js) for dynamic user interfaces. These frameworks handle the front-end aspects of the system, such as form submissions for reassessment requests, displaying reviews, and guiding reassessors through the voting process.

TailwindCSS (or Bootstrap): CSS frameworks like Tailwind or Bootstrap ensure that the user interface is responsive and cleanly styled, which enhances user interaction.

### Backend:

Node.js with Express.js: The backend is built with Node.js and Express.js to handle the server-side logic, such as receiving reassessment requests, coordinating votes, and communicating with AI services. Node.js allows for high performance and scalability in handling multiple reassessments simultaneously.

Python (FastAPI): FastAPI is used for AI services (e.g., reassessor selection and review analysis). Python's FastAPI is an efficient framework that can handle AI-powered tasks like Natural Language Processing (NLP), OCR, and image recognition.

### Databases:

PostgreSQL/MySQL: These relational databases are used for structured data such as user profiles, votes, and review details. They ensure the integrity of the core data, especially when multiple users interact with the system.

MongoDB: A NoSQL database like MongoDB is used for semi-structured data, including NLP results, logs, and user activity. This data is more flexible and can vary in structure based on the reassessment request or AI analysis.

### AI/ML Tools:

TensorFlow/PyTorch: These are used for training machine learning models to handle the reassessor selection process, predict biases in reviews, and provide accurate feedback.

Hugging Face Transformers/spaCy: These libraries are used for Natural Language Processing, enabling the system to analyze text-based reviews and detect sentiments, key themes, and biases.

Tesseract OCR/Google Cloud Vision: These tools extract text from images or supporting documents. Tesseract handles OCR for local processing, while Google Cloud Vision API offers enhanced visual recognition capabilities.

### DevOps:

Docker & Kubernetes: Docker containerizes the application, making it portable across different environments, while Kubernetes handles container orchestration, allowing the system to scale up or down based on demand.

Cloud Hosting (AWS/Google Cloud): PeerVal is deployed on cloud platforms to ensure availability, security, and performance. Storage services like AWS S3 store uploaded files (e.g., supporting documents or images for reviews).

### 3. Step-by-Step Development Instructions

### 3.1 Setup Development Environment:

The development environment for PeerVal includes setting up the necessary tools, frameworks, and libraries for both the backend and AI services. Here's how it works:

### Installing Required Tools:

Node.js: The runtime environment for JavaScript is installed to run the backend built with Express.js.

Python: Python 3.9+ is required for AI tasks like reassessor selection and NLP.

PostgreSQL/MySQL and MongoDB: These databases are set up to handle structured and semi-structured data.

Docker and Kubernetes: These are critical for containerization and orchestration to ensure the system runs consistently across environments.

Tesseract OCR/Google Cloud SDK: Installed for text extraction from images and handling image recognition tasks.

### Installing Python Packages:

Python packages like FastAPI and Transformers are installed to power AI services. These libraries allow the system to build endpoints for tasks like reassessor selection and NLP-based review analysis.

### Installing Node.js Packages:

Express.js and other essential packages (cors, body-parser, etc.) are installed to set up the backend and create API routes to handle requests. Mongoose is used to manage MongoDB connections, and multer is employed to manage file uploads.

### Setting Up Git Repository:

A Git repository is initialized to manage version control, track changes, and collaborate on development.

### Creating Project Structure:

The project structure separates the backend, frontend, and AI services into their own directories to organize the development process.

3.2 Backend Development with Node.js:

The backend of PeerVal is built using Node.js and Express.js, which handle HTTP requests, communicate with databases, and serve the front-end. Below is an explanation of how different functionalities are implemented

### Express Server Setup:

The basic Express server handles requests, such as reassessment requests and voting submissions. The server listens on a specified port (e.g., 5000) and sends responses back to users. Express is lightweight and highly efficient for handling API requests.

### API Routes:

Routes are set up to handle key functions:

Reassessment Requests: This route allows sellers to flag reviews for reassessment, submitting supporting documents. The route saves the reassessment request to the MongoDB database, where further analysis is performed.

Voting: This route collects votes from reassessors, stores them in the database, and determines whether the flagged review is valid based on majority votes.

### File Upload Handling:

Multer, a middleware for handling multipart form data, processes file uploads. This is crucial when sellers or service providers submit documents or images to support their reassessment requests.

### Database Integration:

Mongoose is used to connect to MongoDB, defining schemas for User and Reassessment data models. These schemas structure the data for storing user details (e.g., activity scores and reassessment accuracy) and the reassessment requests themselves.

User Authentication with JWT:

JSON Web Tokens (JWT) are implemented to secure endpoints and authenticate users. Users can register or log in, and if credentials are valid, the server generates a JWT token, allowing them to securely interact with the system.

3.3 AI Services with Python and FastAPI:

PeerVal's AI services are built using FastAPI, a Python-based web framework, and are responsible for tasks such as selecting reassessors, analyzing reviews, and handling supporting documents (e.g., OCR and visual recognition). Here's a breakdown:

### FastAPI Server Setup:

FastAPI is used to create endpoints for AI services. The main goal is to run Python-based machine learning models and return results to the backend.

### Reassessor Selection:

The AI model evaluates users' activity scores, reassessment accuracy, and relevant experience to select a pool of reassessors. This ensures that voters are impartial and qualified to assess reviews, reducing bias in the validation process.

### NLP Review Context Analysis:

Hugging Face's transformers library is used to analyze the text of flagged reviews. Sentiment analysis helps identify whether the review is fair or biased, providing reassessors with a summary of key points that may influence their vote.

### OCR and Visual Recognition:

Tesseract OCR extracts text from uploaded images, while Google Cloud Vision API processes visual content. These features allow PeerVal to analyze supporting documents and images (e.g., receipts, product photos) to verify the authenticity of reviews.

### Combined AI Services:

A final function combines OCR, visual recognition, and NLP, processing supporting documents and review text simultaneously. This combined analysis helps provide a well-rounded assessment of the flagged review, aiding the reassessors in making more informed decisions.

4. Frontend Development with React:

The frontend of PeerVal, built using React.js, provides the user interface that sellers, reassessors, and service providers interact with. Here's how the main components work:

### Reassessment Request Interface:

Sellers can submit reassessment requests through an intuitive form. This includes uploading files and entering the review ID to be flagged. React's state management is used to track the form's data, which is then sent to the backend for processing.

### Voting Interface:

Reassessors use this interface to evaluate the flagged review. They can view the original review, any supporting documents, and provide their vote on whether the review is valid or invalid. The system uses React to update the UI dynamically based on reassessor input.

### Displaying OCR and Visual Recognition Results:

When supporting documents are processed (e.g., images analyzed by OCR or Google Cloud Vision), the extracted text and image labels are displayed to reassessors. This additional context ensures that reassessors have all the necessary information before voting.

### 2.1 Backend: Node.js for API Development

The PeerVal backend is built using Node.js and Express.js to handle server-side logic and API endpoints. Below is the core setup for creating the backend:

```
const express = require(‘express’);
const cors = require(‘cors’);
const bodyParser = require(‘body-parser’);
const app = express( );
app.use(cors( ));
app.use(bodyParser.json( ));
app.get(‘/’, (req, res) => {
  res.send(‘PeerVal Backend API is running’);
});
app.listen(5000, ( ) => {
  console.log(‘Backend server started on port 5000’);
});
```

### API Routes for Reassessment Requests and Voting

```
// Route to handle reassessment requests
app.post(‘/api/reassessment’, (req, res) => {
  const { reviewId, sellerId, supportingDocuments } = req.body;
  // Save reassessment request to the database
  // Trigger AI services for reassessor selection
  res.send(‘Reassessment request submitted’);
});
// Route for reassessors to submit their votes
app.post(‘/api/vote’, (req, res) => {
  const { reassessmentId, reassessorId, vote } = req.body;
  // Save vote to database, update review status if needed
  res.send(‘Vote submitted’);
});
```

### File Upload for Supporting Documents

```
  const multer = require(‘multer’);
  const upload = multer({ dest: ‘uploads/’ });
  app.post(‘/api/reassessment’, upload.array(‘files’), (req, res) => {
    const files = req.files;
    // Process uploaded files
    res.send(‘Files uploaded’);
  });
```

### MongoDB Integration for Data Storage

```
  const mongoose = require(‘mongoose’);
  mongoose.connect(‘mongodb://localhost:27017/peerval’, {
    useNewUrlParser: true,
    useUnifiedTopology: true,
  });
  const UserSchema = new mongoose.Schema({
    username: String,
    email: String,
    password: String,
    activityScore: Number,
    reassessmentAccuracy: Number,
  });
  const ReassessmentSchema = new mongoose.Schema({
    reviewId: String,
    sellerId: String,
    status: String, // Pending, Upheld, Canceled
    supportingDocuments: [String],
    votes: [{ reassessorId: String, vote: String }],
  });
  const User = mongoose.model(‘User’, UserSchema);
  const Reassessment = mongoose.model(‘Reassessment’,
ReassessmentSchema);
```

User Authentication with JWT

```
const jwt = require(‘jsonwebtoken’);
const bcrypt = require(‘bcrypt’);
// Registration endpoint
app.post(‘/api/register’, async (req, res) => {
  const hashedPassword = await bcrypt.hash(req.body.password, 10);
  const user = new User({ ...req.body, password: hashedPassword });
  await user.save( );
  res.send(‘User registered’);
});
// Login endpoint
app.post(‘/api/login’, async (req, res) => {
  const user = await User.findOne({ email: req.body.email });
  const valid = await bcrypt.compare(req.body.password, user.password);
  if (valid) {
    const token = jwt.sign({ id: user._ id }, ‘secret’);
    res.send({ token });
  } else {
    res.status(401).send(‘Unauthorized’);
  }
});
```

### 3. AI Services: Python for Reassessor Selection, NLP Analysis, OCR, and Visual Recognition

### FastAPI Server for AI Services

from fastapi import FastAPI
app = FastAPI( )
@app.get(“/”)
async def root( ):
return {“message”: “PeerVal Al Services Running”}

### AI-Powered Reassessor Selection

```
  @app.post(“/select-reassessors”)
  async def select_reassessors(request_data: dict):
    # Implement AI model to select reassessors based on user activity and
accuracy
    selected_reassessors = [“user123”, “user456”]
    return {“reassessors”: selected_reassessors}
```

### NLP Review Context Analysis

```
from transformers import pipeline
nlp_model = pipeline(‘sentiment-analysis’)
@app.post(“/analyze-review”)
async def analyze_review(request_data: dict):
  review_text = request_data[‘reviewText’]
  analysis = nlp_model(review_text)
  return {“analysis”: analysis}
```

### OCR and Visual Recognition for Supporting Documents

```
import pytesseract
from PIL import Image
@app.post(“/ocr”)
async def ocr(file: UploadFile = File(...)):
  image = Image.open(file.file)
  text = pytesseract.image_to_string(image)
  return {“extractedText”: text}
from google.cloud import vision
client = vision.ImageAnnotatorClient( )
@app.post(“/visual-recognition”)
async def visual_recognition(file: UploadFile = File(...)):
  content = await file.read( )
  image = vision.Image(content=content)
  response = client.label_detection(image=image)
  labels = [label.description for label in response.label_annotations]
  return {“labels”: labels}
```

### 4. Frontend: React for User Interface

```
  import React, { useState } from ‘react’;
  import axios from ‘axios’;
  const ReassessmentRequest = ( ) => {
    const [reviewId, setReviewId] = useState(″);
    const [files, setFiles] = useState([ ]);
    const submitRequest = async ( ) => {
      const formData = new FormData( );
      form Data.append(‘reviewId’, reviewId);
      for (let i = 0; i < files.length; i++) {
        formData.append(‘files’, files[i]);
      }
      await axios.post(‘/api/reassessment’, formData);
    };
    return (
      <div>
        <h2>Submit Reassessment Request</h2>
        <input type=“text” value={reviewId} onChange={e =>
setReviewId(e.target.value)} />
        <input type=“file” multiple onChange={e => setFiles(e.target.files)}
/>
        <button onClick={submitRequest}>Submit Request</button>
      </div>
    );
  };
  export default ReassessmentRequest;
```

### DETAILED DESCRIPTION OF FIGURES

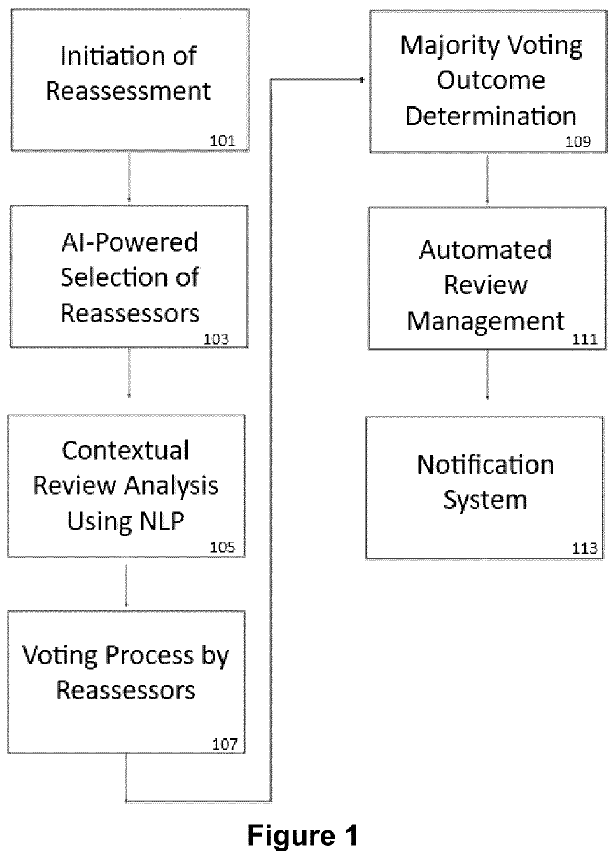

### FIG. 1.101 Initiation of Reassessment

A seller or service provider flags a customer review for reassessment through the Reassessment Request Interface. The flagging might be triggered due to suspected bias, inaccuracies, or personal opinions influencing the review. Sellers can also attach supporting documents or evidence.

### FIG. 1.103 AI-Powered Selection of Reassessors

The AI-Powered Reassessor Selection Engine identifies qualified marketplace users to serve as reassessors. These users are chosen based on their activity levels, account age, past reassessment accuracy, and experience with the product category to ensure an unbiased and informed panel.

### FIG. 1.105 Contextual Review Analysis Using NLP

The flagged review is analyzed by an NLP-Based Context Analysis engine. The engine identifies key topics, sentiments, and potential biases within the review. This helps reassessors understand the context in which the review was written and aids them in making a well-informed decision.

### FIG. 1.107 Voting Process by Reassessors

Reassessors receive the original review, any supporting documents, and insights from the NLP analysis. Based on predefined criteria, such as fairness and accuracy, reassessors vote on whether the review is valid or invalid through the Survey and Voting System.

### FIG. 1.109 Majority Voting Outcome Determination

The Majority Voting Mechanism tallies reassessors' votes. If the majority supports the review, it is upheld. If the majority finds the review invalid, it is flagged for removal or modification, ensuring a community-driven, fair decision.

### FIG. 1.111 Automated Review Management

The Automated Review Management module updates the review's status based on the majority decision. If invalid, the review is automatically removed or flagged for modification on the marketplace platform without manual intervention.

### FIG. 1.113 Notification System

Throughout the process, the Notification System keeps all relevant parties updated. Notifications are sent to the seller or service provider who requested the reassessment, the original reviewer, and the reassessors, informing them of the final outcome.

What is claimed is:

1. A system for reassessing and validating user reviews on digital marketplaces, comprising:
a. An integration module configured to connect with existing marketplace review infrastructures to receive review reassessment requests;
b. A reassessment request interface enabling users to flag and submit customer reviews for reassessment, including the ability to upload supporting documents and evidence;
c. An AI-powered reassessor selection engine designed to select qualified users based on predefined criteria, including user activity, experience, accuracy of past reassessments, and account standing;
d. A natural language processing (NLP) engine for analyzing flagged reviews, identifying sentiment, key topics, and potential biases;
e. A survey and voting system allowing selected reassessors to submit their votes on the validity of the review, based on predefined assessment topics;
f. A majority voting mechanism that computes and finalizes the outcome of the reassessment based on reassessor votes, determining whether the review is upheld or canceled;
g. An automated review management module that updates the review status on the marketplace based on the reassessment outcome;
h. A notification system that sends updates to relevant parties, including the original reviewer, the reassessment requestor, and the reassessors, throughout the reassessment process;
i. A data storage and auditing module that stores reassessment data, votes, and outcomes for quality control, auditing, and future trend analysis.

2. The system of claim 1, wherein the AI-powered reassessor selection engine selects users based on a combination of factors, including:
a. Their previous interactions with the product or service category under review;
b. Their historical reassessment accuracy;
c. The user's marketplace standing and credibility as determined by the platform.

3. The system of claim 1, wherein the NLP-based review context analysis further provides:
a. Sentiment analysis to determine the emotional tone of the review;
b. Topic extraction to identify the key concerns or praises within the review text;
c. A bias detection algorithm that flags potentially biased or unfair statements.

4. The system of claim 1, wherein the survey and voting system guides reassessors in decision-making by presenting structured topics, including:
a. Fairness and objectivity of the review content;
b. Accountability and factual accuracy of claims made by the reviewer;
c. Relevance of the review to the product or service being assessed.

5. The system of claim 1, wherein the majority voting mechanism includes a predetermined threshold of votes that must be met before a review status is changed, ensuring a democratic and objective outcome.

6. The system of claim 1, further comprising:
a. Optical character recognition (OCR) functionality that extracts text from uploaded images and supporting documents to assist reassessors in their evaluation;
b. Visual recognition technology that analyzes images submitted as evidence to verify the authenticity of claims made in the review.

7. The system of claim 1, wherein the automated review management module is further configured to:
a. Remove invalidated reviews from public display on the marketplace;
b. Reinstate upheld reviews with a verified status.

8. The system of claim 1, wherein the notification system sends real-time updates regarding:
a. The reassessment request's progress;
b. The final decision of the review, including reasoning provided by reassessors or the AI system.

9. The system of claim 1, wherein the data storage and auditing module is configured to:
a. Store a log of reassessor decisions to evaluate trends and identify potential biases in future voting patterns;
b. Provide a means for future audits or legal proceedings where validation of the reassessment process is necessary.

10. A method for reassessing the validity of reviews in digital marketplaces, comprising:
a. Submitting a reassessment request for a review, with the option to include supporting documents or evidence;
b. Selecting qualified reassessors using an AI-powered engine that evaluates users based on activity, expertise, and standing;
c. Conducting an NLP-based analysis of the flagged review to provide context to the reassessors;
d. Collecting reassessor votes through a structured survey system;
e. Computing the reassessment outcome using a majority voting mechanism and updating the review's status accordingly.
